(19) United States
(12) Patent Application Publication
(10) Pub. No.: US 2023/0110788 A1
(43) Pub. Date: Apr. 13, 2023

(54) LEARNING DEVICE, LEARNING METHOD, RECORDING MEDIUM, AND RADAR DEVICE

(71) Applicant: NEC Corporation, Minato-ku, Tokyo (JP)

(72) Inventors: Takashi SHIBATA, Tokyo (JP); Motoki Masaka, Tokyo (JP); Yuichi Abe, Tokyo (JP); Kentarou Kudou, Tokyo (JP); Masanori Kato, Tokyo (JP); Shohei Ikeda, Minato-ku, Tokyo (JP)

(73) Assignee: NEC Corporation, Minato-ku, Tokyo (JP)

(21) Appl. No.: 17/797,600

(22) PCT Filed: Feb. 14, 2020
(86) PCT No.: PCT/JP2020/005761

§ 371 Date: Aug. 4, 2022

(51) Int. Cl. G01S 13/72; G01S 13/87; G01S 13/86; G06N 5/022

(52) U.S. Cl. CPC G01S 13/72; G01S 13/867; G01S 13/872; G06N 5/022

(57) ABSTRACT

The learning device learns a tracking model used for a radar device. A first acquisition unit acquires, from a radar device, a target detection information indicating a position of a target detected based on a received wave, and a track of the target calculated based on the target detection information. A second acquisition unit acquires a target position information indicating a position of the target. A learning data generation unit generates learning data using the target detection information, the track, and the target position information. A learning processing unit learns a tracking model for performing tracking processing of the target based on the target detection information, using the learning data.

### TECHNICAL FIELD

The present invention relates to a monitoring technique using a radar.

### BACKGROUND ART

There is known a technique for monitoring a moving object such as an aircraft using radar. Patent Document 1 discloses a method for monitoring a moving target such as an aircraft or a vehicle by a radar device.

### PRECEDING TECHNICAL REFERENCES

### Patent Document

Patent Document 1: Japanese Patent Application Laid-Open under No. 2016-151416

### SUMMARY

### Problem to Be Solved by The Invention

In a radar device having a tracking function, it is necessary to use a tracking filter having both high tracking accuracy and high trackability in order to track a high mobility target performing steep turning or the like. However, it is difficult to realize such a tracking filter actually. In addition, when tracking a target, correlation processing is performed in which the target and the plots are associated. However, in an area where a large amount of clutter exists, there is a fear that the erroneously detected clutter may be associated with the target, resulting in a decrease in tracking accuracy.

One object of the present invention is to realize a radar device capable of performing tracking processing with high tracking accuracy and high trackability.

### Means for Solving The Problem

According to an example aspect of the present invention, there is provided a learning device comprising:
a first acquisition unit configured to acquire, from a radar device, a target detection information indicating a position of a target detected based on a received wave, and a track of the target calculated based on the target detection information;
a second acquisition unit configured to acquire a target position information indicating a position of the target;
a learning data generation unit configured to generate learning data using the target detection information, the track, and the target position information; and
a learning processing unit configured to learn a tracking model for performing tracking processing of the target based on the target detection information, using the learning data.

According to another example aspect of the present invention, there is provided a learning method comprising:
acquiring, from a radar device, a target detection information indicating a position of a target detected based on a received wave, and a track of the target calculated based on the target detection information;
acquiring a target position information indicating a position of the target;
generating learning data using the target detection information, the track, and the target position information; and
learning a tracking model for performing tracking processing of the target based on the target detection information, using the learning data.

According to still another example aspect of the present invention, there is provided a recording medium recording a program, the program causing a computer to execute processing of:
acquiring, from a radar device, a target detection information indicating a position of a target detected based on a received wave, and a track of the target calculated based on the target detection information;
acquiring a target position information indicating a position of the target;
generating learning data using the target detection information, the track, and the target position information; and
learning a tracking model for performing tracking processing of the target based on the target detection information, using the learning data.

According to still another example aspect of the present invention, there is provided a radar device comprising:
a target detection unit configured to transmit a transmission wave, and generate a target detection information indicating a position of the target based on a reception wave corresponding to the transmission wave; and
a tracking processing unit configured to perform tracking processing of the target based on the target detection information using a tracking model, the tracking model being learned using learning data generated based on the target detection information, the track of the target calculated based on the target detection information, and the target position information indicating the position of the target.

### Effect of The Invention

According to the present invention, it is possible to realize a radar device capable of performing tracking processing with high tracking accuracy and high trackability.

### BRIEF DESCRIPTION OF THE DRAWINGS

FIG. 1 illustrates a basic configuration of a radar device.

FIG. 2 illustrates a configuration of a signal processing unit.

FIG. 3 illustrates a configuration for learning a tracking model.

FIG. 4 illustrates a hardware configuration of a learning device.

FIG. 5 is a flowchart of learning processing by the learning device.

FIG. 6 illustrates another example of a learning device.

FIG. 7 illustrates a configuration of the radar device to which the learned model is applied.

FIG. 8 is a flowchart of tracking processing by the radar device.

FIG. 9 illustrates a configuration of another radar device to which the learned model is applied.

FIG. 10 illustrates a configuration for performing a beam control to collect learning data.

FIG. 11 illustrates a configuration for performing on-line learning.

FIG. 12 illustrates a configuration for evaluating validity of a learned model.

FIG. 13 illustrates a configuration for suppressing operation fluctuation by a learned model.

FIGS. 14A and 14B illustrate configurations of a learning device and a radar device according to a second example embodiment.

### EXAMPLE EMBODIMENTS

Preferred example embodiments of the present invention will be described with reference to the accompanying drawings. The radar device in the example embodiments can be used in a monitoring system of moving objects present in the surroundings. Specifically, the radar device detects a moving object (hereinafter, also referred to as a “target”) by emitting transmission waves to the surroundings and receiving the reflected waves thereof, and tracks the target if necessary. Targets include, for example, aircrafts flying in the air, vehicles traveling on the ground, and ships traveling over the sea. In the following example embodiments, for convenience of description, it is supposed that radar device is used for air traffic control and the target is primarily an aircraft.

### Basic Configuration of Radar Device

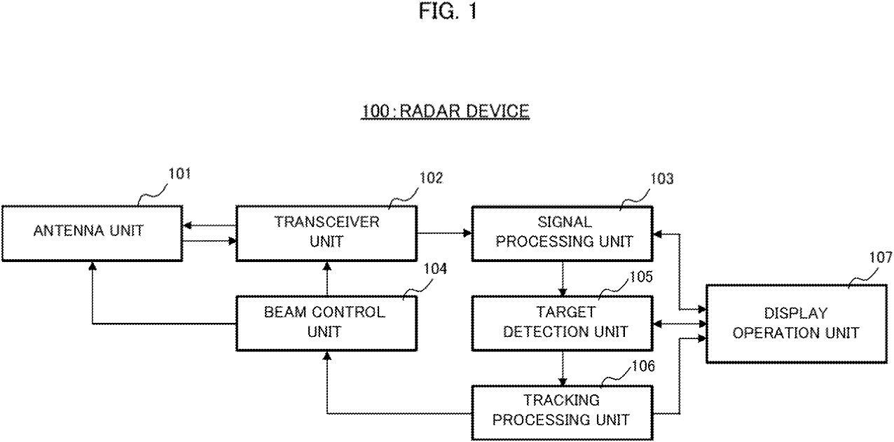

First, the basic configuration of the radar device will be described. FIG. 1 is a block diagram showing a basic configuration of a radar device. The radar device 100 includes an antenna unit 101, a transceiver unit 102, a signal processing unit 103, a beam control unit 104, a target detection unit 105, a tracking processing unit 106, and a display operation unit 107.

The antenna unit 101 amplifies an electric signal inputted from the transceiver unit 102 (hereinafter, also referred to as “transmission signal”), and emits a transmission wave (referred to as “beam”) in the transmission direction instructed by the beam control unit 104. Also, the antenna unit 101 converts the reflected wave of the emitted transmission wave reflected by the target to an electric signal (hereinafter, also referred to as “reception signal”), synthesizes the electric signals and outputs a synthesized signal to the transceiver unit 102.

In this example embodiment, the radar device 100 emits a beam (referred to as a “scan beam”) that constantly scans all directions (ambient 360° ) to monitor the presence of a target in the surroundings. Also, if a target is detected, the radar device 100 emits a beam (referred to as a “tracking beam”) to track that target and tracks the trajectory of the target (referred to as a “track”). From this point, the antenna unit 101 is constituted by an antenna capable of changing the transmission direction instantaneously, such as an array antenna comprising a plurality of antenna elements. Specifically, a plurality of planar array antennas may be arranged to cover all directions, or a cylindrical array antenna may be used. Thus, it is possible to emit the tracking beam in the direction of the target when the target is detected, while constantly emitting the scan beam in all directions.

The transceiver unit 102 generates the electric signal based on the transmission wave specification instructed by the beam control unit 104 (hereinafter, also referred to as beam specification), and outputs the electric signal to the antenna unit 101. The beam specification includes the pulse width of the transmission wave, the transmission timing, and the like. Also, the transceiver unit 102 A/D-converts the reception signal inputted from the antenna unit 101, removes the unnecessary frequency band therefrom, and outputs it to the signal processing unit 103 as a reception signal.

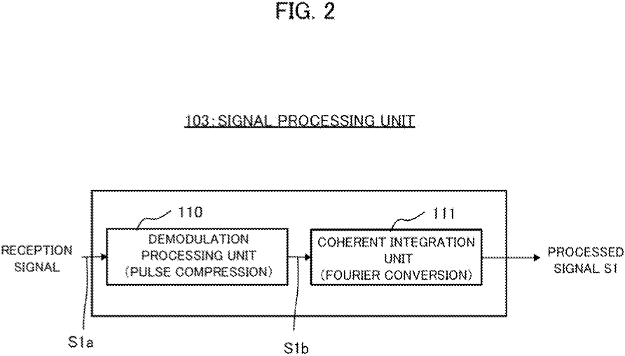

The signal processing unit 103 applies demodulation processing and integration processing to the reception signal inputted from the transceiver unit 102, and outputs the reception signal after the processing (hereinafter, also referred to as “processed signal”) to the target detection unit 105. FIG. 2 is a block diagram showing a configuration of the signal processing unit 103. The signal processing unit 103 includes a demodulation processing unit 110, and a coherent integration unit 111. The demodulation processing unit 110 demodulates (performs pulse compression of) the reception signal inputted from the transceiver unit 102. Essentially, sharp transmission waves (transmission pulses) with high power are required to detect distant targets by radar, but there is a limit to power enhancement due to constraints such as hardware. Therefore, at the time of emitting the beam, the transceiver unit 102 generates the transmission waves of long duration by frequency-modulating the transmission signals having a predetermined pulse width, and transmits them from the antenna unit 101. Correspondingly, the demodulation processing unit 110 demodulates the reception signal inputted from the transceiver unit 102 to generate the sharp reception pulses, and outputs them to the coherent integration unit 111.

The coherent integration unit 111 removes noise by coherently integrating the plural pulses inputted from the demodulation processing unit 110, thereby to improve the SNR. The radar device 100 emits a plurality of pulses in the same direction (in the same azimuth and the same elevation angle) in order to detect the target with high accuracy. The number of pulses emitted in the same direction is called “hit number”. The coherent integration unit 111 integrates the reception signal (the reception pulses) of the beam of a predetermined hit number emitted in the same direction, and thereby improves the SNR of the reception signal. Incidentally, the number of the reception pulses integrated by the coherent integration unit 111 is also referred to as “integration pulse number”. The integration pulse number is basically equal to the hit number of the emitted beam.

Returning to FIG. 1, the target detection unit 105 detects the target from the processed signal inputted from the signal processing unit 103 using a predetermined threshold. The target detection unit 105 measures the distance, the azimuth, and the elevation of the target, and outputs them as the target detection result (hereinafter, referred to as “plot”) to the tracking processing unit 106. The plot includes the distance, the azimuth, the elevation, and the SNR of the target. Further, the target detection unit 105 sets the threshold value for detecting the target, based on the threshold setting value inputted from the display operation unit 107.

The tracking processing unit 106 performs tracking processing for a plurality of plots inputted from the target detection unit 105 and calculates the track of the target. Specifically, the tracking processing unit 106 predicts the position of the target at the current time (referred to as “estimated target position”) based on the plurality of plots, and outputs it to the display operation unit 107. Further, the tracking processing unit 106 calculates the predicted position of the target (referred to as “predicted target position”) based on the plurality of plots and outputs it to the beam control unit 104. The predicted target position indicates the position where the radar device 100 irradiates the tracking beam next.

Specifically, the tracking processing unit 106 performs correlation processing and tracking filtering. The correlation processing is processing of associating a plurality of plots acquired by the target detection unit 105 with the target. When multiple targets are detected at the same time, it is determined which target each of the acquired multiple plots corresponds to, and each plot is associated with each target. The tracking filtering calculates the track of the target using the plots associated with the target. Thus, the estimated target position indicating the current position of the target and the predicted target position indicating the predicted position of the target in the future are obtained.

The beam control unit 104 determines the transmission direction and the beam specification of the scan beam according to a preset beam schedule. Further, the beam control unit 104 determines the transmission direction and the beam specification of the tracking beam based on the predicted target position inputted from the tracking processing unit 106. Then, the beam control unit 104 outputs the transmission directions of the scan beam and the tracking beam to the antenna unit 101, and outputs the beam specification of the scan beam and the tracking beam to the transceiver unit 102.

The display operation unit 107 includes a display unit such as a display, and an operation unit such as a keyboard, a mouse, and operation buttons. The display operation unit 107 displays the positions of the plurality of plots inputted from the target detection unit 105, and the predicted target position inputted from the tracking processing unit 106. This allows the operator to see the current position and/or the track of the detected target. Further, by operating the display operation unit 107, the operator can input the threshold used for the target detection to the target detection unit 105 or input the clutter determination result that the signal processing unit 103 uses for demodulation processing to the signal processing unit 103. Incidentally, the “clutter” is a signal generated by the emitted radar reflected by the object other than the target. Out of the plurality of plots displayed on the display operation unit 107, the operator can determine an area that is considered to be clutter due to experience, and operate the display operation unit 107 to designate the area. This is called “clutter determination”.

With the above configuration, the radar device 100 detects the target by constantly emitting the scan beam in all directions, and emits the tracking beam to the predicted target position to track the target when the target is detected.

### First Example Embodiment

In a radar device having a tracking function, it is necessary to use a tracking filter having both high tracking accuracy and high trackability in order to track a high mobility target performing steep turning or the like. However, it is difficult to realize such a tracking filter actually. Also, when tracking a target, correlation processing is performed in which the target and the plots are associated. However, in an area where a large amount of clutter exists, there is a fear that the erroneously detected clutter may be associated with the target, resulting in a decrease in tracking accuracy. In this view, in the present example embodiment, tracking processing is performed using a model generated by machine learning. Specifically, the tracking model is learned using the plots obtained by the target detection unit 105 and the teacher labels (correct labels) for the plots, and the learned tracking model is applied to the tracking processing unit. Thus, it becomes possible to improve the tracking performance while suppressing the cost.

### Configuration at The Time of Learning

### Whole Configuration

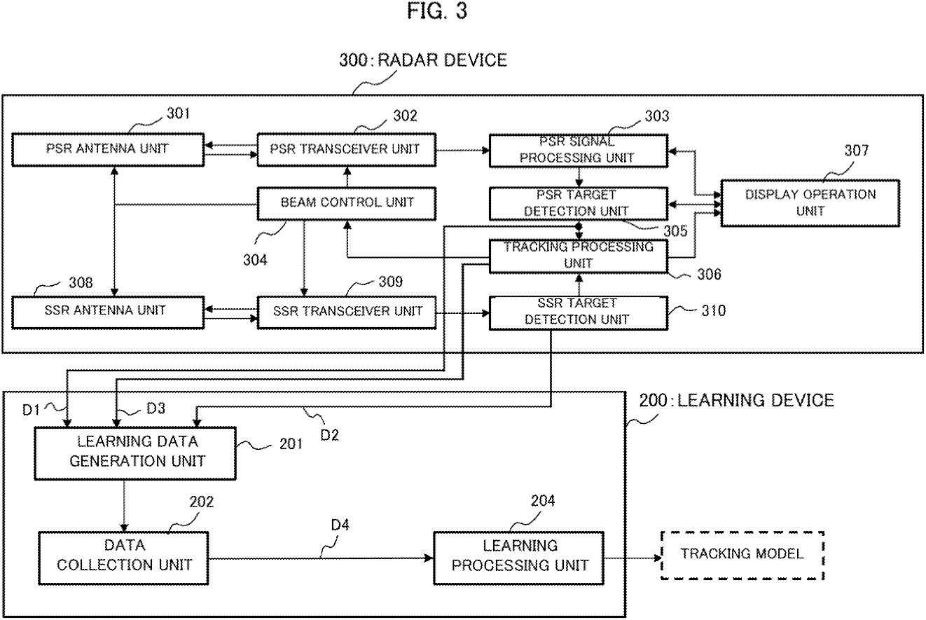

FIG. 3 shows a configuration of a radar device 300 and a learning device 200 according to the present example embodiment. At the time of learning a tracking model, a radar device 300 including a primary radar (PSR: Primary Surveillance Radar) and a secondary radar (SSR: Secondary Surveillance Radar) is used. As shown, the radar device 300 includes a PSR antenna unit 301, a PSR transceiver unit 302, a PSR signal processing unit 303, a beam control unit 304, a PSR target detection unit 305, a tracking processing unit 306, and a display operation unit 307. These units have the same configuration as the antenna unit 101, the transceiver unit 102, the signal processing unit 103, the beam control unit 104, the target detection unit 105, the tracking processing unit 106, and the display operation unit 107 shown in FIG. 1, and operate in the same manner. Further, the radar device 300 includes an SSR antenna unit 308, an SSR transceiver unit 309, and an SSR target detection unit 310.

The SSR transceiver unit 309 outputs an interrogation signal to the SSR antenna unit 308, and the SSR antenna unit 308 transmits an interrogation wave to the target. Further, the SSR antenna unit 308 receives the reply wave to the interrogation wave from the target and outputs the reply signal to the SSR transceiver unit 309. The SSR transceiver unit 309 performs A/D conversion or the like of the reply signal and outputs it to the SSR target detection unit 310. Normally, the reply signal includes the position information of the target, and the SSR target detection unit 310 generates a plot D2 of the target (referred to as an “SSR plot”) based on the reply signal and outputs it to the tracking processing unit 306. The tracking processing unit 306 generates a track D3 of the target using the plot D1 of the target (referred to as a “PSR plot”) detected by the PSR target detection unit 305 and the SSR plot D2. The PSR plot is an example of the primary radar plot, and the SSR plot is an example of the secondary radar plot.

The learning device 200 is provided to learn a tracking model to be applied to the tracking processing unit. The learning device 200 includes a learning data generation unit 201, a data collection unit 202, and a learning processing unit 204. The learning data generation unit 201 receives the PSR plot D1 from the PSR target detection unit 305, receives the SSR plot D2 from the SSR target detection unit 310, and receives the track D3 from the tracking processing unit 306. The learning data generation unit 201 generates a teacher label relating to the track of the target using the SSR plot D2 and the track D3. Specifically, the teacher label includes the position, speed, and acceleration of the target, as well as information indicating true target/false target (true/false of the target). Incidentally, “true target” refers to a correct target such as an aircraft, and “false target” refers to an object misrecognized as a target, such as a clutter.

As described above, since the tracking processing unit 306 performs the correlation processing and the tracking filtering as the tracking processing, the tracking model to be learned is also configured as a model for performing the correlation processing and the tracking filtering. The learning data generation unit 201 first generates a teacher label indicating whether each PSR plot is the true target or the false target using the SSR plot D2. Since the SSR plot D2 is obtained for the target that replied to the interrogation signal, the learning data generation unit 201 basically assigns a teacher label of “a true target” to the PSR plot D1 for which the corresponding SSR plot D2 exists, and assigns a teacher label of “a false target” to the PSR plot D1 for which the corresponding SSR plot D2 does not exist. By using the generated true/false target teacher labels in the learning, the tracking model becomes possible to determine whether the inputted PSR plot D1 is a true target or a false target. Thus, it is possible to prevent that the plot obtained by erroneously detecting a clutter or the like is associated with the target in the correlation processing, thereby enabling stable tracking.

Further, the learning data generation unit 201 generates a teacher label such as the position, the speed, and the acceleration of the target for each PSR plot D1 on the basis of the SSR plot D2 and the track D3. If a target such as an aircraft has transmitted a reply signal including its own position, the position can be used as a fairly accurate target position. Further, the learning data generation unit 201 can determine the speed, acceleration, and the like of the target corresponding to the PSR plot D1 on the basis of the track D3. By learning the model using the teacher labels such as the position, speed, and acceleration of the target thus generated, the tracking model can learn the motion performed by various targets, and it becomes possible to perform the tracking processing with high tracking accuracy and high trackability.

The learning data generation unit 201 uses a pair of the PSR plot and the teacher label generated for the PSR plot in the above manner as the learning data and outputs the pair to the data collection unit 202. The data collection unit 202 stores the learning data inputted from the learning data generation unit 201. The data collection unit 202 stores the learning data to which the teacher labels of the position, speed, acceleration, and true/false of the target are given, for each PSR plot. The learning processing unit 204 acquires the learning data from the data collection unit 202 to learn the tracking model and generates the learned tracking model.

### Hardware Configuration of Learning Device

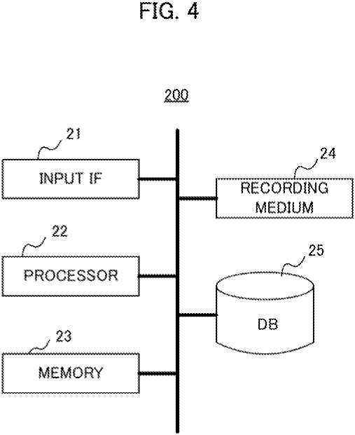

FIG. 4 is a block diagram illustrating a hardware configuration of the learning device 200 illustrated in FIG. 3. As illustrated, the learning device 200 includes an input IF (InterFace) 21, a processor 22, a memory 23, a recording medium 24, and a database (DB) 25.

The input IF 21 inputs and outputs data to and from the radar device 300. Specifically, the input IF 21 acquires the PSR plot S1, the SSR plot D2 and the track D3 from the radar device 300. The processor 22 is a computer including a CPU (Central Processing Unit), a GPU (Graphics Processing Unit), and the like, and controls the entire learning device 200 by executing a program prepared in advance. The processor 22 functions as the learning data generation unit 201 and the learning processing unit 204 shown in FIG. 3.

The memory 23 is composed of ROM (Read Only Memory), RAM (Random Access Memory), and the like. The memory 23 stores various programs to be executed by the processor 22. The memory 23 is also used as a work memory during the execution of various processes by the processor 22.

The recording medium 24 is a non-volatile, non-transitory recording medium such as a disk-shaped recording medium, a semiconductor memory, or the like, and is configured to be detachable from the learning device 200. The recording medium 24 records various programs to be executed by the processor 22. When the learning device 200 performs processing, a program recorded on the recording medium 24 is loaded into the memory 23 and executed by the processor 22.

The DB 25 stores data inputted through the input IF 21 and data generated by the learning device 200. Specifically, the DB 25 stores the PSR plots D1, the SSR plots D2 and the tracks D3 inputted from the radar device 300, as well as the learning data generated by the learning data generation unit 201.

### Learning Processing

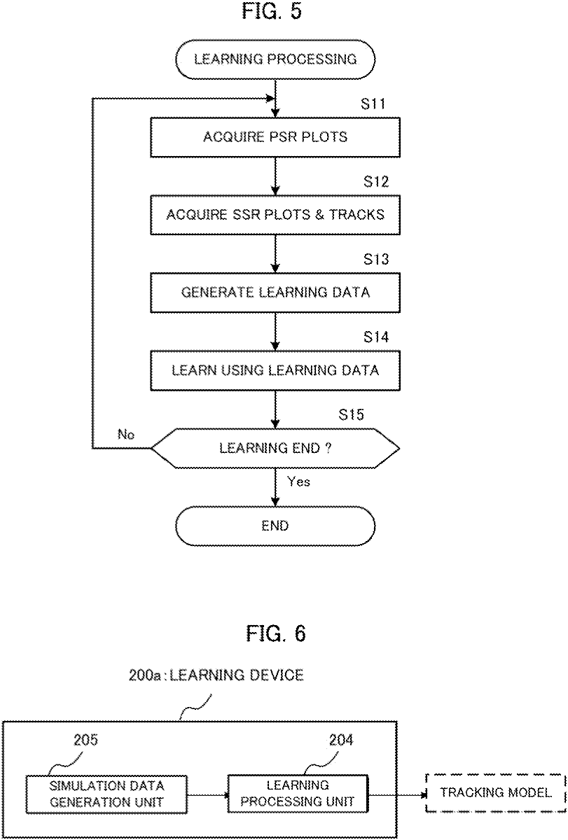

FIG. 5 is a flowchart of learning processing performed by the learning device 200. This processing can be implemented by the processor 22 shown in FIG. 4, which executes a program prepared in advance and operates as each element shown in FIG. 3.

First, the learning data generation unit 201 acquires the PSR plots D1 outputted by the PSR target detecting unit 305 of the radar device 300 (step S11). Also, the learning data generation unit 201 acquires the SSR plots D2 outputted by the SSR target detecting unit 310 and the tracks D3 outputted by the tracking processing unit 306 (step S12). Next, the learning data generation unit 201 generates the learning data including the PSR plots D1 and the teacher labels corresponding to the PSR plots D1 using the PSR plots D1, the SSR plots D2, and the tracks D3, and stores the learning data in the data collection unit 202 (step S13). Next, the learning processing unit 204 learns the tracking model using the inputted learning data (step S14).

Next, the learning processing unit 204 determines whether or not a predetermined learning end condition is satisfied (step S15). An example of the learning end condition is that learning using a predetermined amount of learning data or learning of a predetermined number of times has been completed. The learning processing unit 204 repeats the learning until the learning end condition is satisfied. When the learning end condition is satisfied, the processing ends.

### Other Examples of Learning Devices

FIG. 6 shows another example of the learning device. The learning device 200 shown in FIG. 3 generates the learning data using the PSR plots, the SSR plots and the tracks, that is, the actual data generated in the actual radar device 300. Instead, learning data may be prepared by simulation and learning may be performed. FIG. 6 shows a learning device 200a using simulation data. The learning device 200a includes a simulation data generation unit 205 and a learning processing unit 204. The simulation data generation unit 205 generates learning data (simulation data) including the PSR plots in various situations and the teacher labels corresponding thereto by simulation and inputs the learning data to the learning processing unit 204. The learning processing unit 204 is basically the same as that shown in FIG. 3 and learns the tracking model using the simulation data. Incidentally, the example of FIG. 3 and this example may be combined to learn one tracking model by using the learning data generated based on the actual data of the radar device 300 together with the simulation data.

### Radar Device Using The Tracking Model

### Configuration

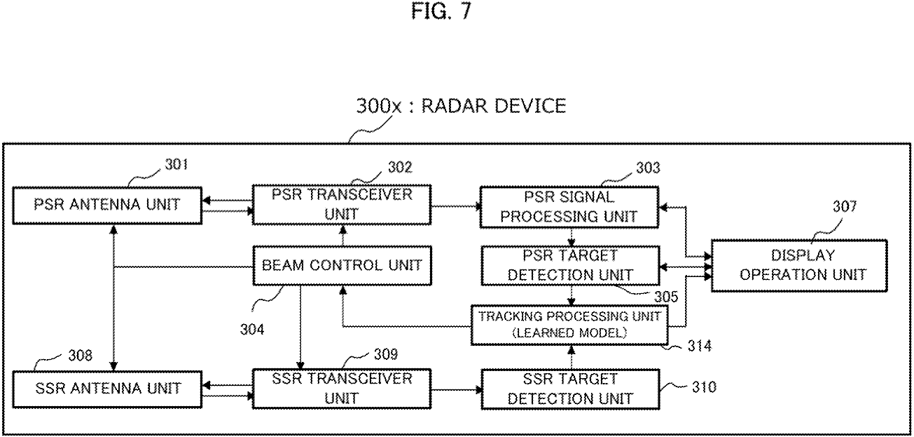

FIG. 7 is a block diagram showing a configuration of a radar device 300x to which a learned tracking model is applied. As can be seen from comparison with FIG. 3, the radar device 300x includes a tracking processing unit 314 instead of the tracking processing unit 306 in FIG. 3. Since the configuration other than the tracking processing unit 314 is the same as that in FIG. 3, the description thereof will be omitted.

A learned tracking model generated by the learning processing described above is set to the tracking processing unit 314. The tracking processing unit 314 detects the target from the inputted PSR plots using the learned tracking model. Specifically, the tracking processing unit 314 calculates the track of the target from the PSR plots using the tracking model. Then, the tracking processing unit 314 outputs the estimated target position to the display operation unit 307 and outputs the predicted target position to the beam control unit 304.

### Tracking Processing

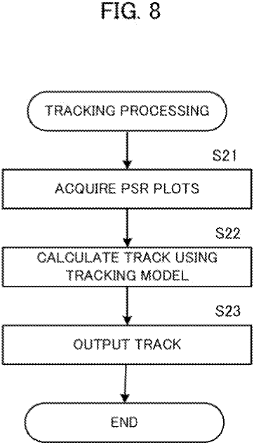

FIG. 8 is a flowchart of tracking processing by the radar device 300x. First, the tracking processing unit 314 acquires the PSR plots from the PSR target detection unit 305 (step S21). Next, the tracking processing unit 314 calculates the track of the target using the learned tracking model based on the acquired PSR plots (step S22), and outputs the track of the detected target (step S23).

As described above, in the present example embodiment, by learning the tracking model using the teacher labels of the true target/false target for the PSR plots, the tracking processing unit 314 can determine whether the inputted PSR plot is a true target or a false target. Thus, it is possible to prevent that the plot obtained by erroneously detecting a clutter or the like is associated with the target in the correlation process. Further, by learning the tracking model using the teacher labels such as the position, speed, and acceleration of the target with respect to the PSR plots, the tracking processing unit 314 can learn the motion performed by the various targets, and both tracking accuracy and trackability may be improved.

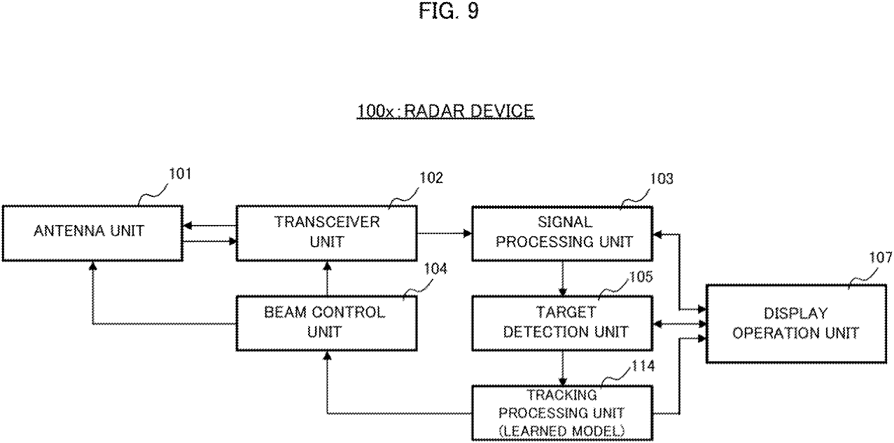

In the example of FIG. 7, the learned tracking model is applied to the radar device including the SSR shown in FIG. 3. Instead, the learned tracking model may be applied to the radar device only having the PSR as shown in FIG. 1. FIG. 9 shows an example in which a learned tracking model is applied to the radar device 100x only for PSR. As can be understood by comparing with FIG. 1, the radar device 100x is the same as the radar device 100 illustrated in FIG. 1 except that a learned tracking model is used in the tracking processing unit 114.

### Generation of Learning Data

### SNR Deterioration

Learning of the tracking model may be performed using learning data with deteriorated SNR, for example, by intentionally adding noise to the PSR plots used as input data when learning the tracking model. This makes it possible to generate a tracking model with high accuracy even in environments with low SNR.

### Method of Generating Teacher Labels

When the learning data is generated in the learning device 200, the teacher label indicating the target position or the true target/false target can be generated in the following manner.

### (A)Use of Secondary Radar

As described in the above-described example embodiment, first, the learning data generation unit 201 may generate the teacher label based on the reply signal received from the target when the target has responded to the interrogation signal transmitted from the secondary radar. Specifically, the learning data generation unit 201 may use the PSR plot corresponding to the target that has transmitted the reply signal as the true target and use the self-position of the target included in the reply signal as the target position.

In the case of using the secondary radar, it is not ensured that the reply is acquired from all targets. In the case of an air defense radar or the like, aircrafts detected as the targets include military aircrafts or the like in addition to passenger aircrafts. An aircraft whose identity has been identified, such as a passenger aircraft and a military aircraft of their own country (hereinafter referred to as “a friendly aircraft”) responds to the interrogation signal, but an aircraft whose identity cannot be identified, such as a military aircraft of other countries (hereinafter referred to as “an unknown aircraft”) do not respond to the interrogation signal. Therefore, a teacher label cannot be generated for the reception signal including the unknown aircraft as the target. However, in the case of the air defense radar or the like, what we really want to detect and track is the unknown aircraft rather than the friendly aircraft.

In this view, a correct answer is generated for the unknown aircraft by the following method. As a premise, it is assumed that the targets that can be detected as the targets from the reception signals are classified to three classes: “clutter (including noise)”, “friendly aircraft” and “unknown aircraft”. It is noted that, when the target is “clutter”, it means that the target does not actually exist but the clutter is erroneously detected as the target. Here, the class that replies to the interrogation signal of the secondary radar and is given the teacher label (given the correct answer) is only the “friendly aircraft”. In addition, the characteristics of the reception signals are similar for both “unknown aircraft” and “friendly aircraft” because they are actually aircrafts.

Under the above premise, the unknown aircraft is detected by the following procedure.

First, by using the reception signals of “friendly aircraft”, the learning data generation unit 201 generates a model for extracting the reception signals of “clutter”, “friendly aircraft”, and “unknown aircraft” from all the reception signals (Process 1).

Next, using the reception signals of “clutter”, “friendly aircraft”, and “unknown aircraft” thus extracted, the learning data generation unit 201 determines the reception signal having a characteristic close to the “friendly aircraft” among the reception signals that are not determined to be “friendly aircraft” (i.e., the reception signals determined to be “clutter” or “unknown aircraft”) to be “unknown aircraft”, and generates “unknown aircraft label” (Process 2).

Then, the learning data generation unit 201 generates a model for detecting “unknown aircraft” from the reception signals using the reception signals determined to be “unknown aircraft” and the “unknown aircraft label” (Process 3).

By this model, it becomes possible to detect unknown aircrafts which do not reply to the interrogation signal of the secondary radar from the reception signals.

In reality, it is conceivable that the accuracy of the “unknown aircraft label” generated in the above-described Process 2 becomes a problem. In that case, the “unknown aircraft label” may be given by hand of an operator or the like. By this method, it is sufficient to manually perform labelling of “unknown aircraft” only for the reception signals having a characteristic close to the “friendly aircraft” among the reception signals determined to be “clutter” or “unknown aircraft” extracted in the above-described Process 2. In other words, it is sufficient to manually perform labelling after narrowing down the reception signals to those having a high possibility of “unknown aircraft” by Process 1 and Process 2. Therefore, compared with the case where manual labeling is performed on the reception signals including all of “clutter”, “friendly aircraft”, and “unknown aircraft”, the amount of manual work can be remarkably reduced.

### (B) Use of Other Radar Devices

In the above example embodiment, SSR is used to acquire the position of the target and generate the teacher labels. However, when there are multiple radar devices, the learning data generation unit 201 may generate the teacher labels using the plots and the tracks acquired from other radar devices. Further, the learning data generation unit 201 may generate the teacher labels using the track (passive track) of the passive radar that only performs reception. Incidentally, the “passive track” is a result of tracking the jamming transmitter based on the jamming wave, and the learning data generation unit 201 can generate the estimated position of the jamming transmitter as the teacher label using the passive track.

### (C) Use of Other Measurement Device

If the target aircraft is equipped with a positioning device such as GPS, the output may be received to generate a teacher label. The same applies when the target is a drone. In addition, a stereo camera or the like may be used to estimate the position of the target from the captured image of the target to generate the teacher label. Incidentally, when the target is a ship, the ship information may be received from the automatic vessel identification device (AIS: Automatic Identification System), and the position of the target may be acquired to generate the teacher label.

### (D) Manual Labeling

The operator may apply a teacher label by viewing the plots, track, or the like displayed on the display operation unit 107.

### In Case of Radar Mounted on Mobile Body

In the above example embodiment, it is assumed that the radar device is installed on the ground. However, the method of the present example embodiment is also applicable to a radar device mounted on a mobile body such as an aircraft or a ship. In that case, as an input parameter used by the tracking model, the mobile body information (the position, the posture, the speed, the course and the like of the mobile body itself) relating to the mobile body on which the radar device is mounted may be used. Specifically, the mobile body information is inputted to the learning data generating device 201, and the learning processing unit 204 performs learning of the model using the mobile body information as the learning data, in addition to the PSR plots. In the radar device 100x or 300x to which the learned model is applied, the mobile body information may be inputted to the tracking processing unit 114 or 314, and the tracking processing unit 114 or 314 may perform tracking processing using the mobile body information.

### Efficient Data Collection by Radar Device

As mentioned previously, it is difficult to collect the learning data necessary for learning of the tracking model for rarely occurring situations. Therefore, the radar device 300 performs beam control for collection of learning data during the beam schedule. Particularly, if the pre-specified condition is satisfied, the radar device 300 performs the beam control intensively. The content of the beam control is changed to match the data to be collected.

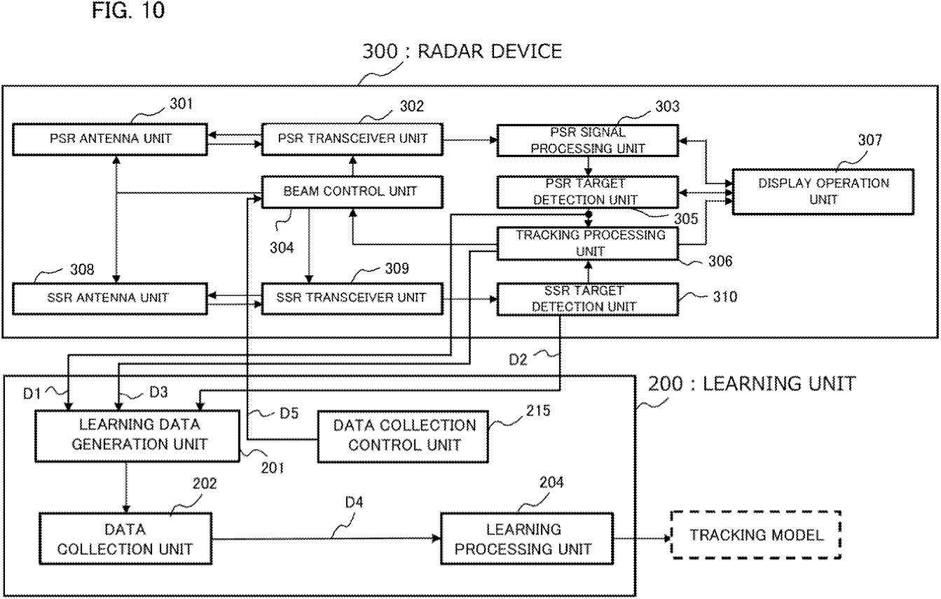

FIG. 10 shows a configuration to perform the beam control for collection of learning data. The radar device 300 has the same configuration as in FIG. 3. Meanwhile, the learning device 200 includes a data collection control unit 215 in addition to the configuration shown in FIG. 3. The data collection control unit 215 stores a condition in which the learning data is insufficient, and outputs a data collection request D5 including the condition of the data to be collected to the beam control unit 304 of the radar device 300. During the beam schedule, the beam control unit 304 controls the antenna unit 301 to emit a beam under the condition indicated by the data collection request D5. The radar device 300 constantly monitors all directions by the scan beam and tracks the target by the tracking beam when the target is detected. Therefore, the beam control unit 304 can emit a beam for collecting learning data, when a target is not detected or when there is no need to track the target, for example. The reflected wave corresponding to the emitted beam is received by the antenna unit 301, and the reception signal is inputted to the PSR target detection unit 305 through the PSR transceiver unit 302 and the PSR signal processing unit 303. The PSR plots generated by the PSR target detection unit 305 are outputted to the learning data generation unit 201. Thus, the learning device 200 can collect data corresponding to the condition in which data is insufficient.

### Application of Learned Model

### On-Line Learning

When the learned tracking model (hereinafter, simply referred to as a “learned model”) generated by the learning device 200 is actually applied to the radar device 100, the operation of the radar device 100 needs to be stopped because rewriting the program or the like occurs. However, the radar device performing important monitoring cannot be stopped. Therefore, the learned model cannot be applied, and the on-line learning is difficult.

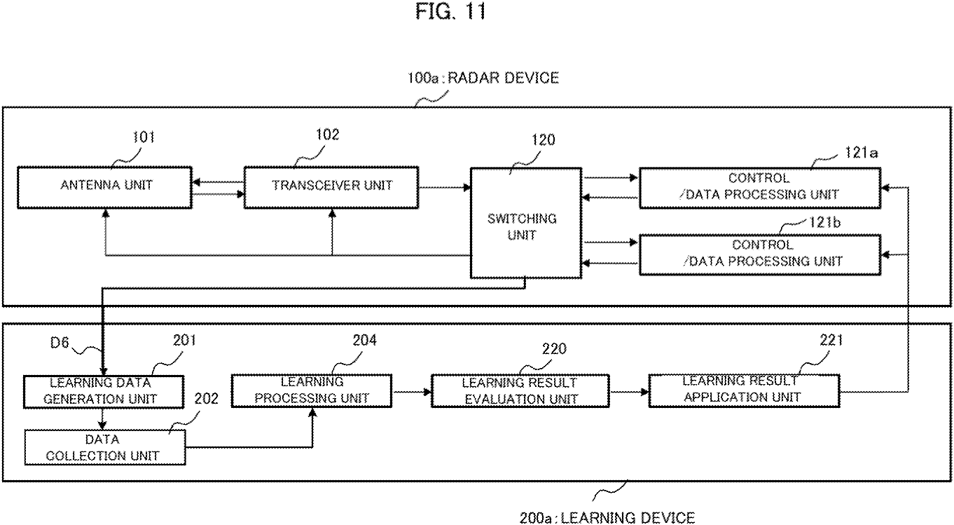

In this view, the control/data processing unit of the radar device is doubled in advance. For convenience of explanation, description will be given of the case where the learned model is applied to the radar device only having a PSR radar. FIG. 11 shows a configuration of a radar device and a learning device for performing on-line learning. As illustrated, the radar device 100a includes an antenna unit 101, a transceiver unit 102, a switching unit 120, and two control/data processing units 121a and 121b. The control/data processing units 121a and 121b are units including a signal processing unit 103, a beam control unit 104, a target detection unit 105, a tracking processing unit 106, and a display operation unit 107 of the radar device shown in FIG. 1. The switching unit 120 selectively connects one of the control/data processing units 121a and 121b to the antenna unit 101 and the transceiver unit 102. In addition, the switching unit 120 outputs the data D6 including the reception signals, the plots, the track, and the like to the learning data generation unit 201 of the learning device 200a from the control/data processing unit 121a or 121b in operation.

The learning device 200a includes a learning result evaluation unit 220 and a learning result application unit 221 in addition to the learning data generation unit 201, the data collection unit 202, and the learning processing unit 204. The learning result evaluation unit 220 evaluates the learned model generated by the learning processing unit 204, and outputs the learned model determined to be applicable to the radar device 100a to the learning result application unit 221. The learning result application unit 221 applies the learned model determined to be applicable to the control/data processing units 121a and 121b.

It is now assumed that the control/data processing unit 121a is in the active state, i.e., during the actual monitoring operation, and the control/data processing unit 121b is in the standby state. Namely, the switching unit 120 is connecting the control/data processing unit 121a to the antenna unit 101 and the transceiver unit 102. In this case, the learning device 200a learns the tracking model using the data D6 outputted from the control/data processing unit 121a in the active state. During this time, the learning result applying unit 221 applies the learned model determined to be applicable to the control/data processing unit 121b in the standby state and rewrites the program.

Next, the switching unit 120 sets the control/data processing unit 121b to the active state, sets the control/data processing unit 121a to the standby state, and applies a new learned model to the control/data processing unit 121a in the standby state. In this way, it is possible to learn the tracking model while continuing the monitoring operation on one of the control/data processing units 121a and 121b and apply the learned model to the other of the control/data processing units 121a and 121b. Namely, it becomes possible to apply the learned model and to carry out the on-line learning.

### Evaluating Model Validity

In the on-line learning, it is difficult to judge how much the learning should be made to ensure the appropriate radar function, i.e., the validity. Further, there is a fear that the tracking processing unit to which the learned model is applied may operate in an unexpected manner, e.g., it erroneously detects a clutter that is not erroneously detected by a conventional processing, and recovery at that time is required. Therefore, the validity of the learned model is judged by operating the control/data processing unit to which the learned model is applied and the control/data processing unit in which the conventional processing is performed in parallel and comparing the processing results of them.

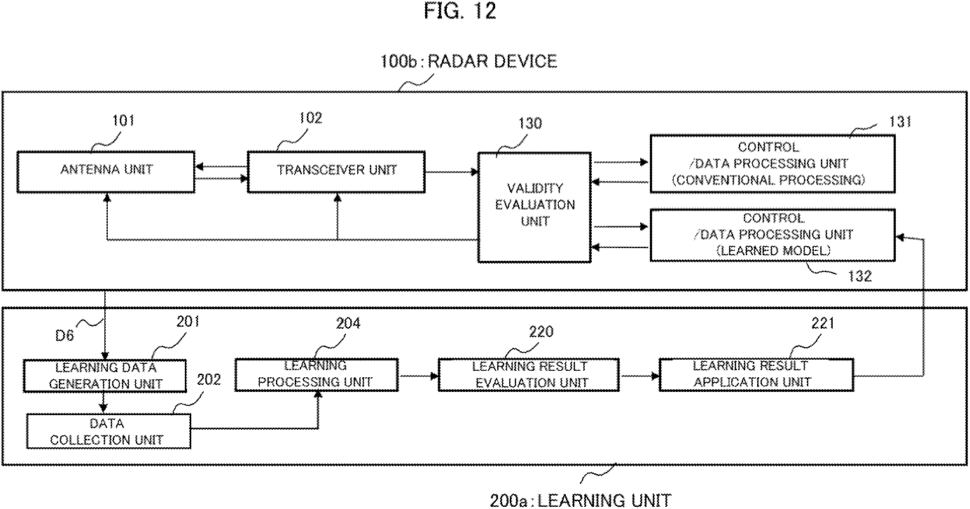

FIG. 12 shows a configuration of a radar device and a learning device for performing validity evaluation of the learned model. As shown, the radar device 100b includes an antenna unit 101, a transceiver unit 102, a validity evaluation unit 130, and two control/data processing units 131 and 132. The control/data processing unit 131 performs the conventional processing, and the control/data processing unit 132 performs processing using the learned model. The control/data processing units 131 and 132 include a signal processing unit 103, a beam control unit 104, a target detection unit 105, a tracking processing unit 106, and a display operation unit 107 of the radar device shown in FIG. 1. The learning device 200a is the same as that shown in FIG. 11.

The validity evaluation unit 130 compares the processing result of the conventional processing performed by the control/data processing unit 131 with the processing result of the learned model performed by the control/data processing unit 132 to determine the validity of the processing result of the learned model. When it is determined that the processing result of the learned model is not appropriate, the validity evaluation unit 130 outputs the processing result of the conventional processing to the antenna unit 101 and the transceiver unit 102. On the other hand, when it is determined that the processing result of the learned model is appropriate, the validity evaluation unit 130 outputs the processing result of the learned model to the antenna unit 101 and the transceiver unit 102. Even when it is determined that the processing result of the learned model is appropriate, the validity evaluation unit 130 may interpolate the processing result of the learned model with the processing result of the conventional processing to prevent an unexpected operation from occurring. Further, the validity evaluation unit 130 may be generated using machine learning or the like. Further, it is not necessary that the processing of the validity evaluation unit 130 is fully automatic, and the operator may be interposed. For example, the operator may determine the validity of the processing result of the learned model based on the information displayed on the display operation unit 107.

### Suppressing Operational Fluctuation in Using The Learned Model

When the learned model is applied to the target detection unit, the operation of the radar device 100 may change significantly. Therefore, the control/data processing unit of the radar device 100 is doubled in advance, the learned model is applied with intentionally shifting the time of applying the learned model, and the results of the processing of the two control/data processing units are integrated to be adopted as a formal processing result.

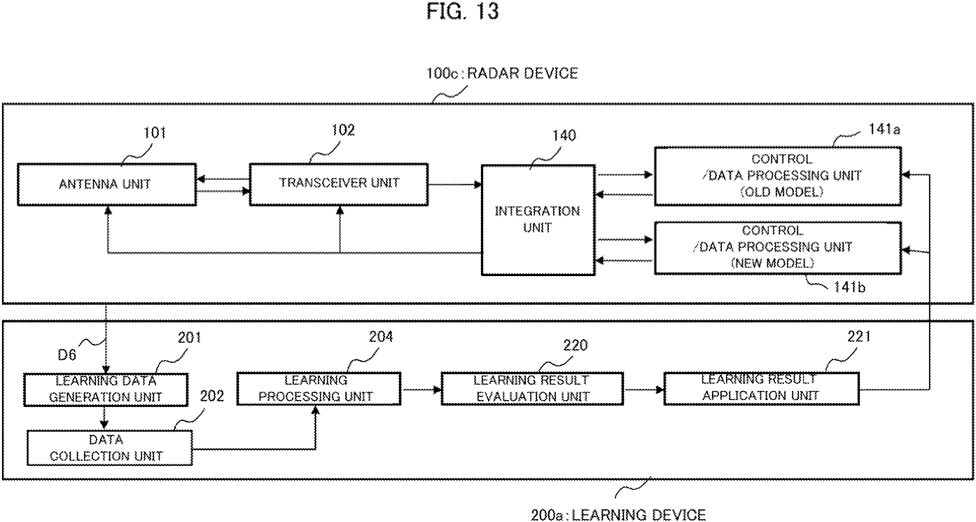

FIG. 13 shows a configuration of a radar device and a learning device for suppressing operational fluctuation by the learned model. As illustrated, the radar device 100c includes an antenna unit 101, a transceiver unit 102, an integration unit 140, and two control/data processing units 141a and 141b. The control/data processing unit 141a uses the old model, and the control/data processing unit 141b uses the new model to perform processing. The control/data processing units 141a and 141b are units including the signal processing unit 103, the beam control unit 104, the target detection unit 105, the tracking processing unit 106, and the display operation unit 107 of the radar device shown in FIG. 1. The learning device 200a is the same as that shown in FIG. 11.

The integration unit 140 integrates the processing results of the control/data processing units 141a and 141b and employs the integrated result as a formal processing result. For example, the integrating unit 140 adds the processing results from the control/data processing units 141a and 141b, divides the result of the addition by 2, and employs the result as the processing result. Thus, it becomes possible to suppress that the operation of the radar device fluctuates greatly when a new learned model is applied.

### Second Example Embodiment

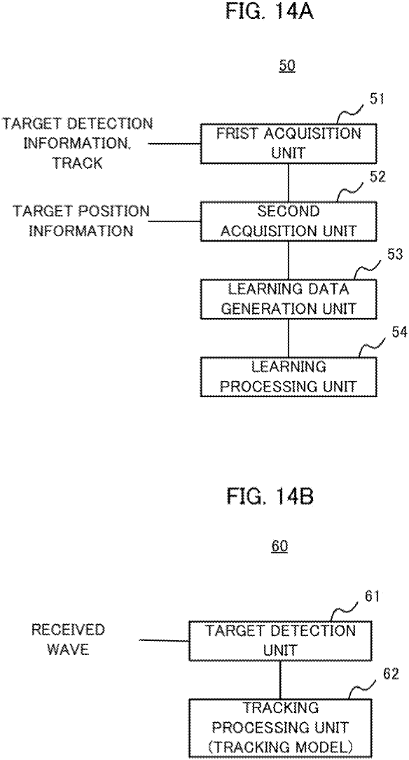

FIG. 14A is a block diagram illustrating a functional configuration of a learning device according to a second example embodiment. A learning device 50 of the second example embodiment includes a first acquisition unit 51, a second acquisition unit 52, a learning data generation unit 53, and a learning processing unit 54. The first acquisition unit 51 acquires, from a radar device, a target detection information indicating a position of a target detected based on a received wave, and a track of the target calculated based on the target detection information. The second acquisition unit 52 acquires a target position information indicating a position of the target. The learning data generation unit 53 generates learning data using the target detection information, the track, and the target position information. The learning processing unit 54 learns a tracking model for performing tracking processing of the target based on the target detection information, using the learning data.

FIG. 14B is a block diagram illustrating a functional configuration of a radar device according to a second example embodiment. The radar device 60 includes a target detection unit 61, and a tracking processing unit 62. The target detection unit 61 transmits a transmission wave, and generates a target detection information indicating a position of the target based on a received wave corresponding to the transmission wave. The tracking processing unit 62 performs tracking processing of the target based on the target detection information using a tracking model. The tracking model is learned using learning data generated based on the target detection information, the track of the target calculated based on the target detection information, and the target position information indicating the position of the target.

A part or all of the example embodiments described above may also be described as the following supplementary notes, but not limited thereto.

### Supplementary Note 1

A learning device comprising:
a first acquisition unit configured to acquire, from a radar device, a target detection information indicating a position of a target detected based on a received wave, and a track of the target calculated based on the target detection information;
a second acquisition unit configured to acquire a target position information indicating a position of the target;
a learning data generation unit configured to generate learning data using the target detection information, the track, and the target position information; and
a learning processing unit configured to learn a tracking model for performing tracking processing of the target based on the target detection information, using the learning data.

### Supplementary Note 2

The learning device according to Supplementary note 1, wherein the learning data generation unit generates a teacher label indicating whether the target indicated by the target detection information is a true target or a false target, based on the target position information.

### Supplementary Note 3

The learning device according to Supplementary note 1 or 2, wherein the learning data generation unit generates a teacher label including a position, a speed, and an acceleration of the target indicated by the target detection information, based on the target position information and the track.

### Supplementary Note 4

The learning device according to any one of Supplementary notes 1 to 3,
wherein the target detection information is a primary radar plot generated by a primary radar of the radar device, and
wherein the target position information is a secondary radar plot generated by a secondary radar.

### Supplementary Note 5

The learning device according to Supplementary note 4, wherein the secondary radar plot is generated by the radar device that has generated the primary radar plot.

### Supplementary Note 6

The learning device according to Supplementary note 4, wherein the secondary radar plot is generated by a radar device different from the radar device that generated the primary radar plot.

### Supplementary Note 7

The learning device according to any one of Supplementary notes 1 to 6, wherein the target position information is self-position information of the target included in a received signal from the target.

### Supplementary Note 8

The learning device according to any one of Supplementary notes 1 to 7, wherein the target position information is generated based on a captured image of the target by a stereo camera.

### Supplementary Note 9

The learning device according to any one of Supplementary notes 1 to 8, further comprising a request unit configured to transmit a transmission wave matching a predetermined condition and request the radar device to generate the target detection information corresponding to the condition.

### Supplementary Note 10

The learning device according to any one of Supplementary notes 1 to 9,
wherein the radar device is mounted on a mobile body,
wherein the learning device further comprises a third acquisition unit configured to acquire mobile body information including a position and movement information of the mobile body, and
wherein the learning data generation unit generates the learning data using the mobile body information.

### Supplementary Note 11

A learning method comprising:
acquiring, from a radar device, a target detection information indicating a position of a target detected based on a received wave, and a track of the target calculated based on the target detection information;
acquiring a target position information indicating a position of the target;
generating learning data using the target detection information, the track, and the target position information; and
learning a tracking model for performing tracking processing of the target based on the target detection information, using the learning data.

### Supplementary Note 12

A recording medium recording a program, the program causing a computer to execute processing of:
acquiring, from a radar device, a target detection information indicating a position of a target detected based on a received wave, and a track of the target calculated based on the target detection information;
acquiring a target position information indicating a position of the target;
generating learning data using the target detection information, the track, and the target position information; and
learning a tracking model for performing tracking processing of the target based on the target detection information, using the learning data.

### Supplementary Note 13

A radar device comprising:
a target detection unit configured to transmit a transmission wave, and generate a target detection information indicating a position of the target based on a reception wave corresponding to the transmission wave; and
a tracking processing unit configured to perform tracking processing of the target based on the target detection information using a tracking model, the tracking model being learned using learning data generated based on the target detection information, the track of the target calculated based on the target detection information, and the target position information indicating the position of the target.

While the present invention has been described with reference to the example embodiments and examples, the present invention is not limited to the above example embodiments and examples. Various changes which can be understood by those skilled in the art within the scope of the present invention can be made in the configuration and details of the present invention.

### Description of Symbols

200 Learning device
201 Learning data generation unit
202 Data collection unit
204 Learning processing unit
300 Radar device
301 PSR antenna unit
302 PSR transceiver unit
303 PSR signal processing unit
304 Beam control unit
305 PSR target detection unit
306, 114, 314 Tracking processing unit
307 Display operation unit
308 SSR antenna unit
309 SSR transceiver unit
310 SSR target detection unit

What is claimed is:

1. A learning device comprising:
a memory configured to store instructions; and
one or more processors configured to execute the instructions to:
acquire, from a radar device, a target detection information indicating a position of a target detected based on a received wave, and a track of the target calculated based on the target detection information;
acquire a target position information indicating a position of the target;
generate learning data using the target detection information, the track, and the target position information; and
learn a tracking model for performing tracking processing of the target based on the target detection information, using the learning data.

2. The learning device according to claim 1, wherein the one or more processors generate a teacher label indicating whether the target indicated by the target detection information is a true target or a false target, based on the target position information.

3. The learning device according to claim 1, wherein the one or more processors generate a teacher label including a position, a speed, and an acceleration of the target indicated by the target detection information, based on the target position information and the track.

4. The learning device according to claim 1,
wherein the target detection information is a primary radar plot generated by a primary radar of the radar device, and
wherein the target position information is a secondary radar plot generated by a secondary radar.

5. The learning device according to claim 4, wherein the secondary radar plot is generated by the radar device that has generated the primary radar plot.

6. The learning device according to claim 4, wherein the secondary radar plot is generated by a radar device different from the radar device that generated the primary radar plot.

7. The learning device according to claim 1, wherein the target position information is self-position information of the target included in a received signal from the target.

8. The learning device according to claim 1, wherein the target position information is generated based on a captured image of the target by a stereo camera.

9. The learning device according to claim 1, wherein the one or more processors are further configured to transmit a transmission wave matching a predetermined condition and request the radar device to generate the target detection information corresponding to the condition.

10. The learning device according to claim 1,
wherein the radar device is mounted on a mobile body,
wherein the one or more processors are further configured to acquire mobile body information including a position and movement information of the mobile body, and
wherein the one or more processors generate the learning data using the mobile body information.

11. A learning method comprising:
acquiring, from a radar device, a target detection information indicating a position of a target detected based on a received wave, and a track of the target calculated based on the target detection information;
acquiring a target position information indicating a position of the target;
generating learning data using the target detection information, the track, and the target position information; and
learning a tracking model for performing tracking processing of the target based on the target detection information, using the learning data.

12. A recording medium recording a program, the program causing a computer to execute the learning method according to claim 11.

13. A radar device comprising:
a memory configured to store instructions; and
one or more processors configured to execute the instructions to:
transmit a transmission wave, and generate a target detection information indicating a position of the target based on a reception wave corresponding to the transmission wave; and
perform tracking processing of the target based on the target detection information using a tracking model, the tracking model being learned using learning data generated based on the target detection information, the track of the target calculated based on the target detection information, and the target position information indicating the position of the target.
